(19) United States
(12) Patent Application Publication
(10) Pub. No.: US 2006/0212310 A1
(43) Pub. Date: Sep. 21, 2006

(54) Methods to finance, acquire, register, manage and lease aircraft with increased liability protection and wireless connectivity

(76) Inventor: Karl E. Seuring, Redmond, WA (US)

Correspondence Address: BUSKOP LAW GROUP, P.C., 1776 YORKTOWN, SUITE 550, HOUSTON, TX, 77056, US

(21) Appl. No.: 11/375,847

(22) Filed: Mar. 15, 2006

Related U.S. Application Data
(60) Provisional application No. 60/663,105, filed on Mar. 18, 2005.

(51) Int. Cl. G06Q 99/00

(52) U.S. Cl. 705/1

(57) ABSTRACT

The embodiments relate to methods to buy, inspect, finance, structure and manage aircraft begins by firt identifying and aircraft to purchase. After inspection of the aircraft, financing for procurement of the aircraft is exchanged. The method then calls for purchasing the aircraft followed by registering the aircraft with the proper government authorities in a business trust. The invention further provides for a method of managing the trust aircraft through a leasing company. The method provides tax advantages on and off balance sheet structures, roll over of existing aircraft management programs, and privacy to client documentation.

The present application claims priority to co-pending U.S. Provisional Patent Application Ser. No. 60/663,105, filed on Mar. 18, 2005.

### FIELD

The embodiments relate to methods for financing, acquiring, registering and managing business aircraft so that individual companies and high net worth individuals can both (1) avoid having airplanes as an ownership responsibility on their balance sheets (2) have an element of secrecy regarding ownership of publicly exposed aircraft registrations.

### BACKGROUND

In recent years, owning and managing the use of private civilian aircraft has become a fine art. In spite of the improvements in safety and technology, wireless connectivity of aircraft connected to a “real-time” management system has eluded most users of business aircraft. A need exists for a system that can maximize liability protection regarding an aircraft, create confidentiality relative to aircraft registrations, provide alternate finance capital and revenue potential, provide a wireless connectivity between aircraft, and provide an electronic hand-held personal digital assistant and a management system usable by a client, or an investor that optimizes scheduling.

Many aircraft currently have in place on board computers, sophisticated navigation systems, links to the aircraft databases, and report the location of air asset on the plant. However, a need has existed for a system that provides finance, scheduling and communication links to any seat-in the aircraft and enables a client, to tactically manage the repositioning and/or the use of the aircraft, monitor real time charges and deploy air assets in the most profitable manner with the least liability exposure; under maximum confidentiality.

A need exists for methods that use independent accounting, asset finance, a dedicated business leasing structure and tax advantages to maximize and optimize aircraft usage, revenue and business value.

The embodiments meet these needs.

### BRIEF DESCRIPTION OF THE DRAWINGS

The detailed description will be better understood in conjunction with the accompanying drawings as follows:

FIG. 1 is a diagram of an embodiment of the method to buy, inspect, finance, structure and manage aircrafts.

FIG. 2 is a diagram of an example embodiment of financing that can be used with an aircraft in accordance with this method.

FIG. 3 examples activities that the leasing company undertakes according to the method.

The embodiments are detailed below with reference to the listed Figures.

### DETAILED DESCRIPTION OF THE EMBODIMENTS

Before explaining the embodiments in detail, it is to be understood that the embodiments are not limited to the particular embodiments And that they can be practiced or carried out in various ways.

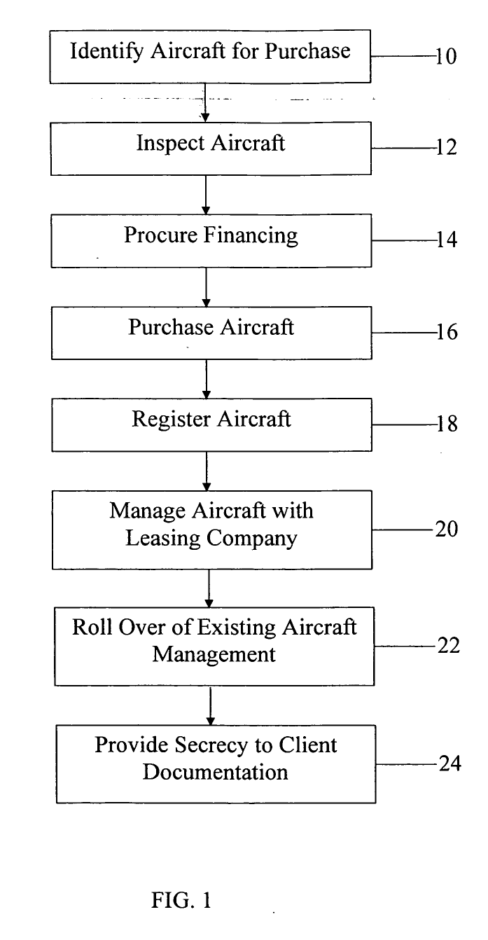

The embodiments relate to methods to finance, acquire, register, manage and lease aircraft. With reference to the figures, FIG. 1 is a diagram of an embodiment of the method to buy, inspect, finance, structure and manage aircrafts. The methods begin by creating, usually by writing, a Representational Agreement (hereafter, RA). The RA describes the business relationship of the parties and a finance package. The information in the RA reflects understandings to be reached in a Memo of Understanding (hereafter, MOA) with the client regarding the acquisition of a potential aircraft by a management company. A deposit can be required with the executed RA.

The methods continue by producing a list of specific aircraft to be viewed and examined as candidates for purchase (10). Specific aircraft are to be viewed and examined as candidates for purchase. Examples of these aircraft include a Learjet ™, a VIP Boeing ™ 757, a Beechraft Baron ™, or a single-engine Cessna™. The list of specific aircraft can be prioritized based on the type of aircraft that best suits the clients' parameters, the pricing base lines stated in the RA, and/or anticipated usage demands for the aircraft.

Special aircraft to be viewed and examined can be located using various known tools of the trade. These tools include AirFAX™, websites, and materials or brokers that provided by the NBAA™, NRAA™, or other reputable groups. Other manners for searching for aircraft include using internet search engines, using classifieds located in aircraft journals, and using other open market avenues.

The methods continue by creating a summary of specific aircraft to be viewed and examined. The summary can include pictures of identified potential aircraft and their fuselages. The summary can include usage details and historic pedigree for each aircraft. Other information, such as the airframe, engine hours, and standard aircraft specifications, can be provided with the summary as well.

After the summary is created, the client agrees to the summary list or other criteria as stated in the RA. Specific aircraft are then inspected (12) by the management company that created the RA. The inspection can include an inspection of each opening in the aircraft, a visual inspection of the overcall craft and cabin, and/or an Eddy Current inspection. The fuselage and wings of the aircraft can be inspected for corrosion and structural damage. The aircraft can be inspected for fluid or pressure leakage. A fit and finish inspection can be performed. Additionally, engines, airframes, flight controls, avionics, brakes, electrical systems, pressurization, fuel tank and system and hydraulics and; if installed, auxiliary power unit(s) can be included in the inspection of the aircraft.

Negotiations are initiated to acquire aircraft that meet the particular criteria. The aircraft to be acquired can include a specific “punch list” of unairworthy, mechanically, or cosmetically deficient items. The negotiations can concern the cost to acquire the plane, can concern due diligence regarding title to the aircraft, and can involve discussion about the items on the punch list to reduce the purchase price.

After negotiations, methods continue with financing (14). Once a particular inspected aircraft is selected as a candidate for purchase and negotiations are wrapping up, the amount of the financing and the source of the financing can be arranged. A formula is used to determine the financing the desired aircraft. The formula closely tracks the financing stated in the client's MOU.

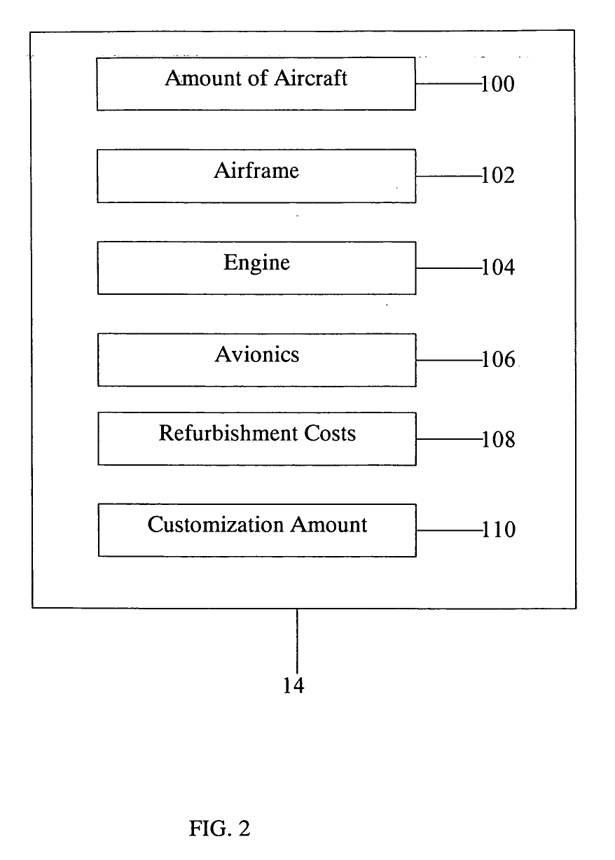

FIG. 2 is a diagram of an example embodiment of financing that can be used with an aircraft in accordance with this method. Financing can be for an overall value of the aircraft (100). The overall value of the aircraft (100) can include the airframe (102) (metal and composite structures), flight control surfaces (103), windows (104), doors (105), wheels (106), tires (107), brakes (108), at least one engine (109); and avionics (110). Avionics (110) can include navigation, communication, lighting, flight control, and autopilot systems. For example, an aircraft, such as a 1998 model year Dassault Falcon 200, can have a total cost to finance of US $4.5 million. The price includes the cost to acquire the aircraft and the cost for refurbishment of the airframe, flight control surfaces, windows, doors, wheels, tires, brakes engine, and avionics with the result being and overall airworthy aircraft.

The financing can cover: a fee for refurbishment of the aircraft (108); an amount for customization of the aircraft (110) that includes the cost of any desired exterior paint;

and the cost for making and installing the desired interior cabinetry, carpeting, upholstery and other electronic accoutrements, such as a satellite television. For example, the refurbishment cost for a Boeing 757™ aircraft can range from US $6 Million to US $18 Million for airframe alterations, customized exterior paint, flight furniture and millwork cabinetry, individual seat communications, externally mounted cameras, security systems, and flat panel screens.

The financing can include the cost for installation and customization of wireless connectivity (112). The wireless connectivity (112) can be used with a land-based database or a service company database that provides management services. The wireless connectivity (112) can include a personal digital assistant that can be connectable to the land based database for “aircraft seat management” of flight schedules and other communications.

As part of the financing, investors can be approached to add capital to the process. These investors can be investors for the leasing company. One method for adding investors is to enable an individual investor-to provide capital in exchange for a Class A Member interest in the leasing company. Other investors can add capital in exchange for Class B member interest in the leasing company. A Class A member interest can be directed at the planes, while the Class B member interest can be directed at the intellectual property of the leasing company. Capital to procure the aircraft from outside investors can be received and granted in exchange for a member interest in the leasing company. Initially, the member interest is “Active”, but the interest can be converted to “Passive” when a “Trust” is used in association with the leasing company. Class A Active Members can include the beneficiaries of the trust. Class A Passive Members can receive continued limited benefits as founders of the Trust along with benefits from sales profits due to participation by Active members.

The financing can be through loans or from outside finance vehicles prearranged by the client or through venture capital investors in a Leasing company. For example, a Singapore bank might hold funds for a specific investor group, and the service company places funds on deposit for a Wall Street investment team to create additional capital or, the leasing company may choose to offer Class A active membership to investors interested in the program.

Once financing is worked out and inspection is complete, the aircraft is purchased using the arranged funds from the financing. A wire transfer moves money from an escrow company of the management company to an independent Trustee. A trustee of the leasing company manages the aircraft in trust for the members. A Limited Power of Attorney (hereafter, LPOT) (111) is granted to the management company to procure the aircraft on behalf of the leasing company using a deposit.

The aircraft is then registered with government authorities. The embodied methods contemplates that the aircraft can be registered in the USA or that foreign government registrations can be used. The trust of the leasing company can be used to register the aircraft. The trust of the leasing company can the beneficiary (18) of the trust. The leasing company name and country location are agreed upon with the client in the MOU. In-country documents of the aircraft leasing company, a Management Operating Agreement (hereafter, MOA), and Articles of Incorporation (hereafter, AOI) can be additionally included.

During registration, entitlement to the aircraft can be legally placed in the trust. The embodied methods contemplates that the trust is a United States of America based business trust or an offshore business trust. By placing the aircraft in a trust, the ownership responsibility of the aircraft is removed from the accounting books of the leasing company and from the accounting and assets of the investors. In addition, the asset is separated from these entities. The name of the beneficiary client or Class A member as described in the MOA will not appear on the aircraft registration. By having the name of the beneficiary client or Class A member not appear on the aircraft registration, the embodied methods provide an additional level of privacy is created to aircraft ownership.

In addition to paying the costs of registration, the deposit rendered by the leasing company via the trust provides the management company with capital to fund aircraft setup charges and provide electronic capabilities and communications with a client that enables remote monitoring of expenses. The management company can use the deposit funds from the MOU to customize client software concurrently, thereby enabling a client to have real time viewing of trip scheduling and summaries of individual aircraft operating expenses.

The embodied methods contemplate that more than one owner or member per aircraft share usage and operating expenses through the dedicated leasing company and the MOA.

The services company can set up a system to pay bills direct to vendors for each customer so that the customer is viewing one bill, as described as once a month billing itemization. The software for providing one bill invoicing is contemplated to be a highly secure system, with critical secrecy, passwords, firewalls, and other devices to keep hackers and other intruders away from the private data of the customer, and the financing information that the customer used to acquire the aircraft.

The service company can utilize wireless connectivity in and to the aircraft that is interfaced to land based databases and is interfaced to a personal digital assistant (PDA), such as Pocket PC like the HP IPAQ™. As cell phones become more powerful, the wireless connectivity can additionally occur through cell phones. Once the wireless connectivity is installed and once the maintenance, fuel, flight operations and catering services are set up, the customer can begin scheduling of the plane. The customer can also communicate directly with the captain, request catering, request hangar services, monitor aircraft charges, and organize schedules with clients all from the comfort of the airline seat. Nonscheduled customization, such as interior wear and tear, can be transmitted as well.

Each customer can monitor all real time expenses for the aircraft for which the services company will charge a nominal fee of about two to seven percent of the service costs. The monitoring can be handled from the PDA, as well as a desktop connected via the Internet. The embodied methods allow the customer to not only schedule the above noted services and monitor costs, but also choose their own pilots and manage airplane services through a customer friendly, wireless hand-held PDA system.

Returning to FIG. 1, the aircraft can be managed through a dedicated aircraft leasing company (20) that is the beneficiary of the trust. A select number of members in the leasing company can share equally in the operations costs of the aircraft as well as the revenue generation ability of the aircraft. Further, the embodied methods can involve providing “roll over” of existing aircraft and or management programs (22) and providing privacy to client documentation (24).

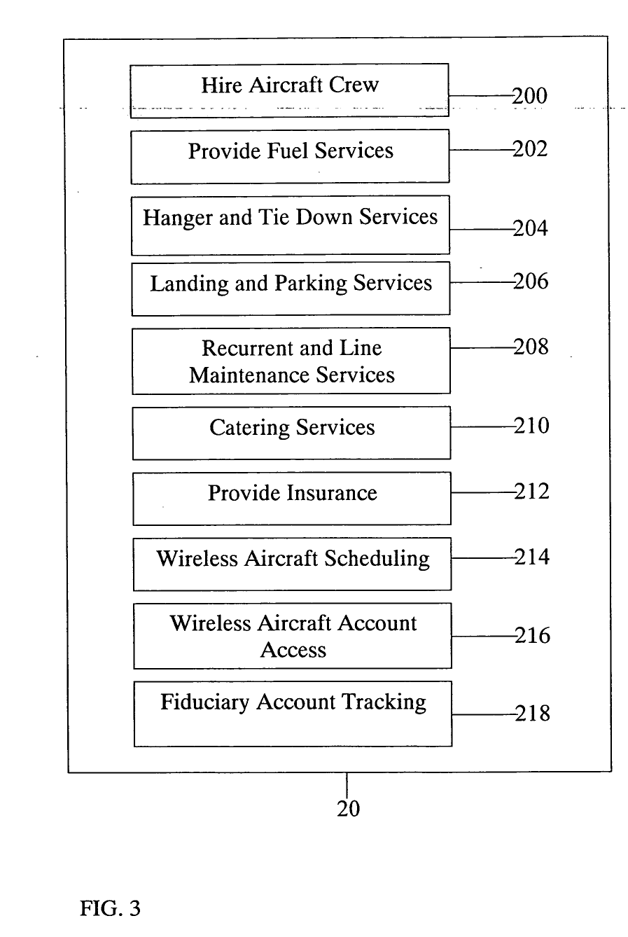

FIG. 3 examples activities that the leasing company undertakes according to the method. A governance document can be provided to each member of the leasing company for operation and separation of multiple owners. The RA, MOU and LPOT determine the finance capabilities of each member. The MOA of the leasing company determines the capital exchange criterion from Active to Passive Class A members.

The following is an example list of responsibilities of a leasing company:

a. to hire aircraft crew to fly the aircraft with a crew services company (200);

b. to provide fuel services from a fuel service provider (202);

c. to provide hanger and tie down services (204);

d. to provide landing and parking services (206);

e. to provide recurrent and line maintenance service providers (208);

f. to provide contracts for on-board catering services (210);

g. to provide insurance commiserate to the level of risk of a customer (212);

h. to provide wireless aircraft scheduling services including flight planning (214);

i. to provide wireless real time aircraft account access for the customer (216); and

j. to provide “tier 1” fiduciary account tracking with tax advantaged on and off balance sheet structures (218) (an example of a “tier 1” is a US or foreign bank with commensurate financial qualifications).

The embodied methods entail that hiring an aircraft crew can be included in the tasks of the leasing company. An aircraft crew can include one or more pilots, copilots, flight attendants, maintenance personnel for working on the aircraft, and combinations thereof.

The embodied methods contemplates that the aircraft can additional be used for revenue purposes outside of the members.

While these embodiments have been described with emphasis on the embodiments, it should be understood that within the scope of the appended claims, the embodiments might be practiced other than as specifically described herein.

What is claimed is:

1. A method to buy, inspect, finance, structure and manage aircrafts comprising the steps of:
(a) identifying an aircraft for purchase;
(b) inspecting the aircraft;
(c) exchanging financing for procurement and purchasing the aircraft;
(d) registering the aircraft with a proper government authority in a business trust;
(e) managing the business trust through a leasing company;
(f) providing tax advantages on and off balance sheet structures;
(g) rolling over existing aircraft management programs; and
(h) maintaining privacy to client documentation.

2. The method of claim 1, wherein the proper government authority is the United States of America.

3. The method of claim 1, wherein the step of registering the aircraft with the proper government authority includes registering the aircraft with domestic or foreign aircraft registrations.

4. The method of claim 1, wherein the account billing access is a single account with the parts selected from the group consisting of flow through, single invoice posting, and combinations thereof.

5. The method of claim 1, wherein the business trust is a trust established in a jurisdiction within the United States of America.

6. The method of claim 1, wherein the business trust is an offshore trust.

7. The method of claim 1, wherein the business trust is managed by a trustee who is independent of the management company and inventor.

8. The method of claim 1, further comprising the step of hiring an aircraft crew, wherein the aircraft crew is selected from the group consisting of pilots, flight attendants, maintenance personnel for working on the aircraft, and combinations thereof.
